(19) United States
(12) Patent Application Publication
(10) Pub. No.: US 2013/0264269 A1
(43) Pub. Date: Oct. 10, 2013

(54) Device with a Separation Surface and a Movable Supplementary Grate for Removing Sieved Material from a Flowing Liquid

(71) Applicant: HUBER SE, Berching (DE)

(72) Inventors: Thomas Kerl, Muhlhausen (DE); Franz Spenger, Rottenbach (DE); Christian Brüderl, Schernfeld (DE)

(73) Assignee: Huber SE, Berching (DE)

(21) Appl. No.: 13/860,082

(22) Filed: Apr. 10, 2013

(30) Foreign Application Priority Data
Apr. 10, 2012 (DE) 10 2012 103 058.8

(51) Int. Cl. C02F 11/12

(52) U.S. Cl. CPC C02F 11/12
USPC 210/396

(57) ABSTRACT

This invention refers to a device for separating and removing sieved material from a flowing liquid such as sewage, in which case the device has a sieve grate (1) with a sieve surface with a front side (2) pointing upstream while the device is operating, in which case the device has a supplementary grate (3) in a lower area of the sieve grate (1) placed upstream before the sieve grate (1), in which case the device has a drive (24) and a cleaning rake (4) that can be driven to revolve in a conveying direction with the help of the drive (24), in which case the operating cleaning rake (4) is moveable along at least one partial section of the front side (2) of the sieve grate (1) in order to remove the held-back sieved material and transport it towards a discharge opening (5) and wherein the cleaning rake (4) can be moved along a back side (6) of the supplementary grate (3) pointing downstream while it is moving in order to remove sieved material held back by the supplementary grate (3) and transport it towards a discharge opening (5). According to the invention, it is suggested to move the supplementary grate (3) relative to the sieve grate (1).

This invention refers to a device for separating and removing sieved material from a flowing liquid such as sewage, in which case the device has a separation surface with a front side pointing upstream while the device is operating, in which case the device has a supplementary grate with a sieve area in a lower area of the separation surface placed upstream preceding the separation surface, in which case the device has a drive and a cleaning rake that can be driven to revolve in a conveying direction with the help of the drive, in which case the operating cleaning rake is moveable along at least one partial section of the front side of the separation surface in order to remove the held-back sieved material and transport it towards a discharge opening, and in which case the cleaning rake can be moved along a back side of the supplementary grate pointing downstream while it is moving in order to remove sieved material held back by the supplementary grate and transport it towards a discharge opening.

Such sieve devices are known, from example, from JP 58007010 A or JP 55039534 A and generally serve for removing coarse sieved material from sewage flowing in a sewer. For this purpose, the sieve devices are integrated into the sewer in such a way that the sieve surface extends perpendicularly or slightly inclined upwards, starting from the sewer floor. In order to make it possible to discharge the sieved material held back by the respective sieve grate, the sieve surface extends farther above the maximum expected water level. Finally, the cleaning rake's revolving operation conveys the sieved material along the sieve surface upwards towards the discharge opening, where it is removed from the cleaning rake with the help of a scraper, for example.

The supplementary grate should finally ensure that no sieved material can pass through the device below the sieve surface designed as a sieve grate (which must be mounted at a certain distance from the sewer floor to allow the cleaning rake to revolve also in the area below the sieve grate).

However, since the cleaning rake when it revolves around the sieve grate must also pass through the supplementary grate, a certain gap must also be provided between sieve grate and supplementary grate so that it cannot be entirely ruled out that smaller sieved material, in particular, passes the sieve device through the gap mentioned above. In this case, full removal of the sieved material from sewage is not possible.

The task of this invention is therefore to improve a genre-related device in such a way that it can eliminate the disadvantage described above.

The task is solved with a sieve device characterized by a moveably mounted additional grate so its position can be changed with respect to the separation surface. Preferably, the separation surface extends (starting from the sewer floor) perpendicularly or obliquely upwards (especially inclined downstream) and finally ends in the above-mentioned discharged opening, from which the held-back sieved material can be removed. The supplementary grate is generally not as high (i.e. oriented perpendicularly with respect to the sewer floor) as the separation surface and merges flush with the sewer floor, for example, through an inserted sealing strip, sealing lip, basic carrier that carries the separation surface or the like, so no sieved material can pass through the sieve device between the supplementary grate and sewer floor.

Finally, because the supplementary grate can be moved, it can be placed as close as possible to the separation surface while the cleaning rake is in an area when it does not make contact with the supplementary grate. Especially during this time period, when the supplementary grate is in the lower area of the sieve device immediately adjacent to the separation surface or contiguous to it, sieved material is effectively prevented from passing the sieve device between separation surface and supplementary grate (as is the case in state of the art). If the cleaning rake, while rotating around the separation surface for cleaning purposes, finally reaches the area of the supplementary grate, the latter can be moved away from the separation surface. As a result of this, a free space or gap between separation surface and supplementary grate is created, through which the cleaning rake can be moved through. After the cleaning rake has passed, the supplementary grate is finally moved back to its initial position, in which it creates, whenever possible, a connecting separation or sieve surface with the separation surface.

In this context, it is particularly advantageous for the separation surface to be designed as a sieve grate having a sieve surface. Alternatively, the separation surface can naturally also be designed like a closed surface element. In these two cases, the sieved material held back by the supplementary grate and/or separation surface can be moved towards the discharge opening with the help of the cleaning rake. Generally speaking, with regard to the cleaning rake, it must be mentioned that it should have cleaning prongs pointing towards the supplementary grate. If the separation surface has been designed as a sieve grate, it is convenient for the cleaning rake to also have the corresponding cleaning prongs on the side facing the sieve grate. If the separation surface, on the other hand, has been designed as a closed surface element or flat sieve surface, then it can be advantageous to design the side of the cleaning rake that faces the separation surface like a scraper in order to allow the cleaning rake to abut the separation surface.

It is particularly advantageous when the cleaning rake is inserted in a control mechanism, preferably via two rotating chains, so the control mechanism ensures that the cleaning rake is moved upwards in the front part of the separation area while it moves in conveying direction and can then be moved downwards once again in its back side area. Thus, while the cleaning rake rotates in a side view of the sieve device ii is led around the separation surface, so that the entire device only has a very small extension when seen in the direction of the sewer. During skimming, the held-back sieved material is finally captured by the cleaning rake (which can include a pushing blade, for example) that transports it upwards along the front part of the separation area. In this case, the guiding rails can induce a two-sided guidance of the rotating chains and/or cleaning rake(s) and/or also a guiding element in the direction of the separation surface. In any case, the guiding element ensures that the rotating chains are reliably guided on a predetermined trajectory. In this process, the rotation of the rotating chains can be initiated either by a control system or manually too. Also, several cleaning rakes can be provided instead of a single one.

It is furthermore advantageous for the separation surface to be designed as a sieve grate and for the supplementary grate and sieve grate to have many grate rods. It is likewise advantageous for the cleaning rake to have a first and second row of cleaning prongs, in which case the cleaning rake can be moved in such a way along the back part of the sieve grate and along the back part of the supplementary grate that the first row of cleaning prongs engages in the spaces arranged between the grate rods of the sieve grate and the second row of cleaning prongs engages between the spaces arranged between the grate rods of the supplementary grate. When this occurs, the individual cleaning prongs can have a length ensuring that that they can partially or also fully grab the sieve grate and/or supplementary grate.

It is likewise advantageous if the cleaning prongs of the second row are longer than the depth of the supplementary grate running perpendicularly to its sieve surface, so that the cleaning prongs of the second row completely penetrate its sieve area when passing the supplementary grate and protrude from the sieve area upstream. Whereas the first row of cleaning prongs (or the contact area of one or several scraping elements of the cleaning rake) sweeps along the front part of the separation area, the cleaning prongs of the second row (which can be arranged on the side opposite the first row of the cleaning rake, for example) must grab through the sieve area of the supplementary grate from behind to capture the sieved material held back by it and be able to transport it upwards.

It is also an advantage if the supplementary grate can be moved from an operating position, in which there is minimum distance between the supplementary grate and the separation area, to a passing position, in which there is a passable free space between the supplementary grate and the separation area. In the operating position, it is furthermore advantageous if the grate rods of the supplementary grate lie directly on the grate rods of the separation surface so a uniform sieve area extending from the sewer floor to the sieve area and upwards is created. However, the supplementary grate must be moveable so much from the operating position with respect to the separation surface that the cleaning rake can pass through the free space created without colliding with the supplementary grate.

In this context, it is advantageous when the supplementary grate can be swiveled around a rotating axis between the operating position and passing position. Apart from linear mobility, swiveling is advantageous because no guiding rails must be provided (which would tend to clog). Rather, the additional rake could have a cross member in its lower part so it can be fastened laterally on the housing of the sieve device or on the sewer wall. In this case, the supplementary grate comprises the cross member mentioned above, from which the individual grate rods extend downstream towards the separation area. Whereas the cross member is generally separated by a constant distance from the separation surface, the distance between the separation surface and the grate rods of the supplementary grate can be changed by swiveling them around its rotating axis.

It is particularly advantageous for the center of gravity of the supplementary grate to be located between the rotating axis of the supplementary grate and the separation surface both in the operating and passing positions, so that the supplementary grate, after passing the cleaning rake, returns from the passing position back to the operating position owing to gravity. In this case, when the cleaning rake passes, the supplementary rake is pressed into its passing position by it and automatically returns to its operating position after the cleaning rake has passed.

It is likewise advantageous when the supplementary grate lies on a rigidly mounted limiter in its passing position. This arrangement prevents the supplementary grate from being moved upstream too much. The limiter can, for example, be made of one or several (rubber) pads on which the supplementary grate can rest in the passing position, for example, on one or several of its grate rods. The limiter should be advantageously placed in the area where the supplementary grate is placed. For example, it can be arranged in a bottom group that surrounds the rotating axis, for example, above which the supplementary grate is brought into contact with the sewer floor during installation. The limiter can also be a border of a grate carrier that supports the grate rods and runs along the width of the supplementary grate and that—starting from a certain swiveling of the supplementary grate that originates in the operating position—makes contact with the sewer floor or a bottom sheet metal of the sieve device and prevents further swiveling.

It is particularly advantageous when the supplementary grate rests on the separation surface and/or a rigidly mounted stop in its operating position. Firstly, it is ensured that there will not be a gap between separation surface and supplementary grate in the operating position through which sieved material can pass the sieve device downstream. Secondly, the stop should be positioned so that a minimum gap between separation surface and supplementary grate remains so the mutual wear of both grate types is prevented. The stop, in turn, can be designed as a pad to prevent hard contact.

It is also advantageous for the cleaning rake to have a first contact area that can be brought into contact with the supplementary grate (preferably with its grate rods) when it passes through, in which case the supplementary grate can be moved from the operating to the passing position with the help of the cleaning rake while moving in conveying direction. The first contact area can be made of rollers (or corresponding sliding elements), for example, arranged in a way so they are distributed over the width of the cleaning rake. In this arrangement, the rollers should be placed so they make contact with its grate rods when the additional rake abuts. The separation of the rollers should therefore correspond to the mutual separation of the grate rods of the supplementary grate or a multiple thereof. It is likewise advantageous when the first contact area is made up of elements (e.g. the rollers mentioned above) placed transversally between the cleaning prongs pointing in the direction facing away from the separation surface. The elements can, for example, be fastened to the cross member that links the individual cleaning prongs with one another.

It is furthermore advantageous for the cleaning rake to have a second contact area that can be brought into contact with at least one lateral guiding element of the supplementary grate when the latter passes, in which case the supplementary grate can be moved with the help of the cleaning rake while it moves against the conveying direction from the operating to the passing position. While a guiding element additionally and advantageously arranged in a lateral area of the supplementary grate can be sufficient, it is also possible to provide two or more guiding elements. It has been demonstrated that it is especially advantageous to place one guiding element on each lateral area of the supplementary grate (i.e. in the area of its external grate rods). In this case, the above-mentioned movement of the supplementary grate is enormously advantageous when the cleaning rake can also be moved against the conveying direction. Such a movement can be desired for loosening wedged sieved material that can no longer be removed in conveying direction. If the cleaning rake reaches the area where the supplementary grate is (preferably) immediately adjacent to the separation area while the rake's “backward movement” was manually or automatically initiated, then it makes contact with the supplementary grate via the second contact area and moves it from its operating to the passing position. In this case, the second contact area is made possible by preferably one or several elements placed in one or the two lateral areas of the cleaning rake. By swinging out the supplementary grate into its passing position, it is finally ensured that the cleaning rake will be able to pass the supplementary rake also against conveying direction without causing a mutual collision.

There are additional advantages if the first contact area is placed before the second contact area in the cleaning rake's conveying direction. If the cleaning rake makes contact with the supplementary grate in conveying direction, then this contact takes place via the first contact area. While the cleaning rake continues to be transported, the supplementary grate finally makes contact with the second contact area, while the first contact area moves away once again from the supplementary grate.

It is also advantageous for the first and/or second contact area to have at least one roller that can be brought into contact with the supplementary grate or its lateral guiding element(s). The guiding rollers allow relatively frictionless movement between cleaning rake and supplementary grate. The first contact area is preferably created out of several rollers arranged separately above the width of the cleaning rake. Alternatively or additionally to the roller(s), sliding elements can generally also be used (e.g. in form of one or several sliding blocks).

There is another advantage when the guiding element of the supplementary grate (which should be preferably arranged on one or both sides of the cleaning rake) protrudes upstream from the sieve area of the supplementary grate when the device is operating. When the cleaning rake approaches the supplementary grate in reverse operation (i.e. while it moves against the conveying direction), it makes contact with the guiding element via the second contact area described above before it reaches the area where the grate rods of the supplementary grate are located. As a result of this, a collision between grate rods and cleaning rake is prevented. Here, the guiding element is arrangement preferably trapezoidal or triangular and preferably delimits the supplementary grate laterally, i.e. in transverse direction.

It is also advantageous for the guiding element to have a run-up slope through which it can be brought into contact with at least the second contact area of the cleaning rake. As a result of this, a smooth swiveling of the supplementary grate from the operating to the passing position is made possible when the cleaning rake is moved against the conveying direction. In addition, the run-up slope can ensure that the transition from the passing to the operating position takes place smoothly when the cleaning rake passes the supplementary grate in conveying direction. This is especially the case when the cleaning rake is in contact with the run-up slope of the supplementary grate when it leaves the area between supplementary grate and separation surface, so that the supplementary grate is slowly swiveled towards the separation surface.

Furthermore, it can be advantageous when the supplementary grate is connected to a lifting unit to help it move (preferably raised) relative to the separation surface. This has the decisive advantage that the supplementary grate can be raised, for example, when the operation of the cleaning rake is no longer ensured for any reason. After such changed placement of the supplementary grate, liquid can finally flow through the lower area of the device according to the invention (where the supplementary grate is normally located). Although in this case the sieved material can no longer be separated because it passes the device together with the liquid in the lower area of the device (without being held back by the supplementary grate that was moved away), when the cleaning rake no longer functions, however, a clogging of the device and its associated uncontrolled accumulation of the liquid is prevented in return.

It is also advantageous when the lifting unit has rods on which the supplementary grate is arranged so it can be preferably moved with respect to the rods. In this way, the built-in supplementary grate can be swiveled, for example, from a passing to an operating position (for a definition of the positions, see above). The rods can also create some sort of frame on which the supplementary grate is fastened. Finally, rods and supplementary grate can be jointly moved (preferably raised) relatively to the separation surface in case of need, so that the described free space—through which liquid can flow—located between the separation surface and the adjoining wall that houses the equipment of the device according to the invention is created (e.g. the floor of a sewer).

It can also be advantageous if the rods include a supporting section extending across the width of the supplementary grate, in which case the supporting section is placed in a lower area of the supplementary grate. The supporting section can furthermore be connected with two bar profiles placed on both sides of the supporting section. The bar profiles, in turn, can be connected to each other with a transverse crossbar in an upper area. In the final analysis, a unit with the corresponding equipment (e.g. in form of a pulley or another lifting device) consisting of rods and supplementary grate is obtained to bring it from a resting to a hoisted position that can also be accessed to perform the respective repair and/or maintenance work if needed.

It is finally advantageous for the lifting unit to be inserted in a guiding element to allow the supplementary grate to be moved on a predefined trajectory. The guiding element can be fastened, for example, to a channel wall that surrounds the device according to the invention. Alternatively, the guiding element can also be part of the device and fastened to a corresponding basic frame of it, for example. In any case, the guiding element should be designed so it can guide lifting unit and supplementary grate during the raising process, thereby preventing their damage or minimizing a risk of injury to the operating staff.

Additional advantages of the invention are described in the following embodiments, which show:

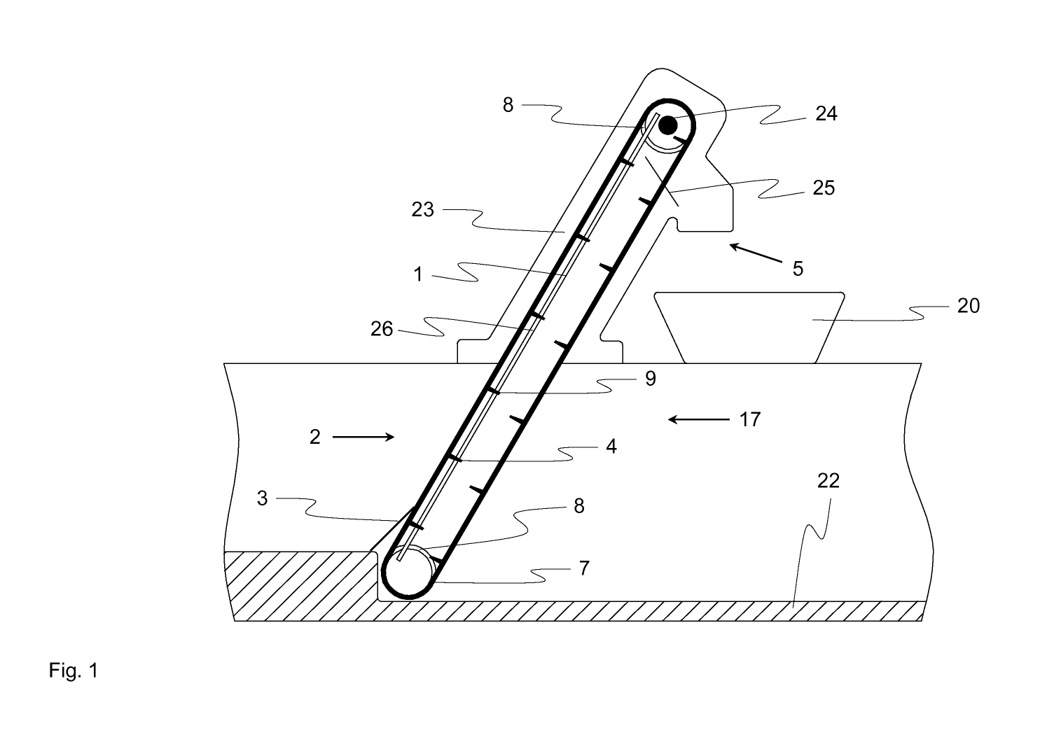

FIG. 1 a lateral view of a known sieve device,

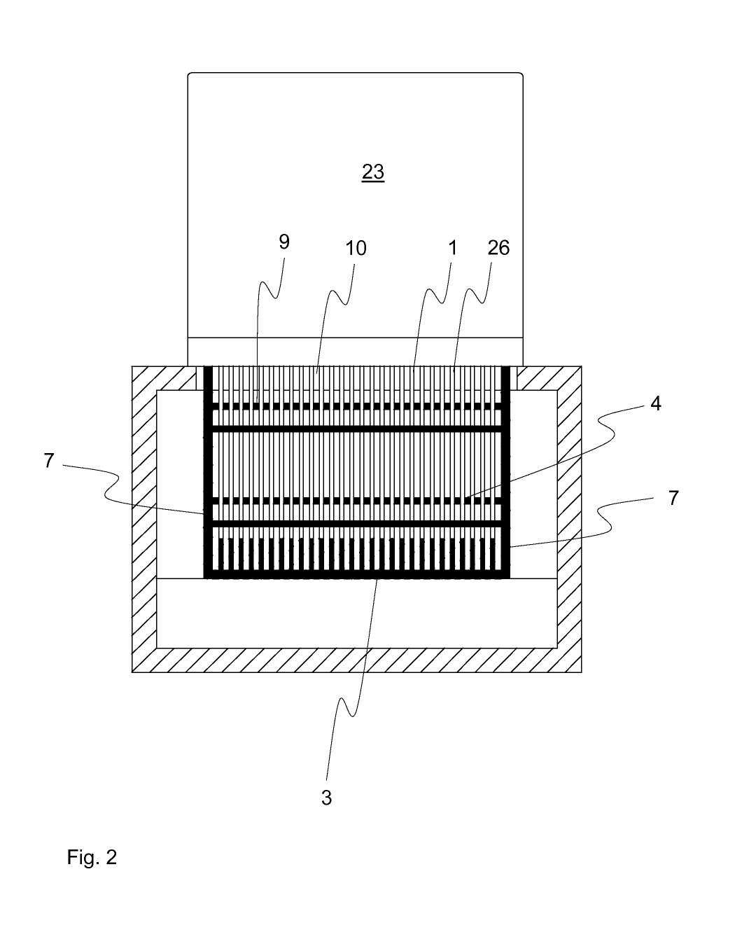

FIG. 2 a front view of the sieve device according to FIG. 1,

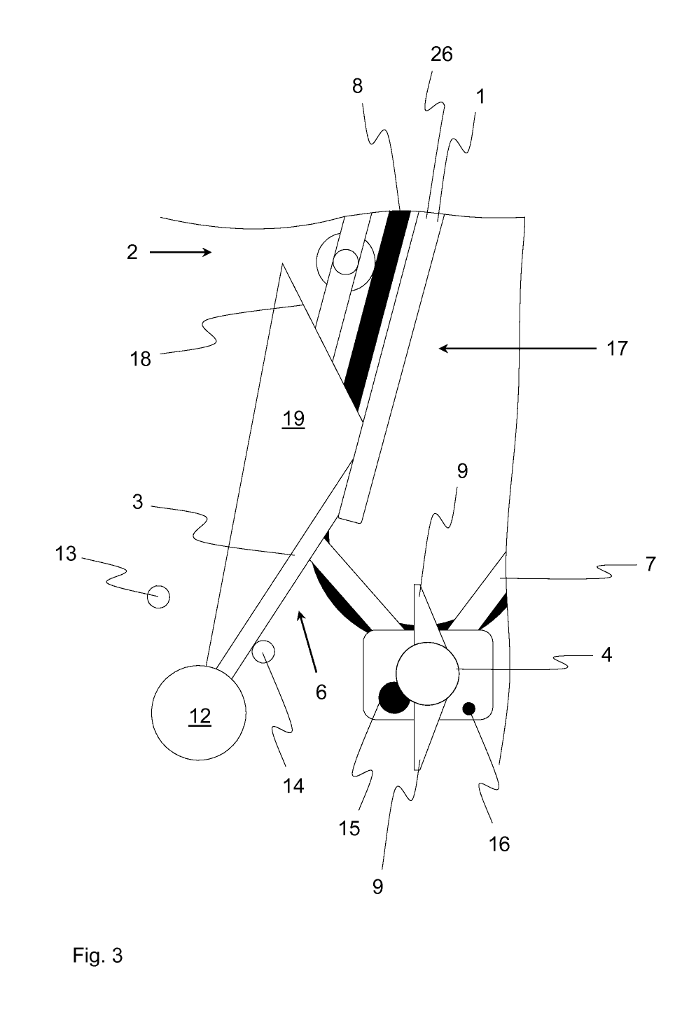

FIGS. 3 to 8 side views of a section of a sieve device according to the invention while a cleaning rake rotates,

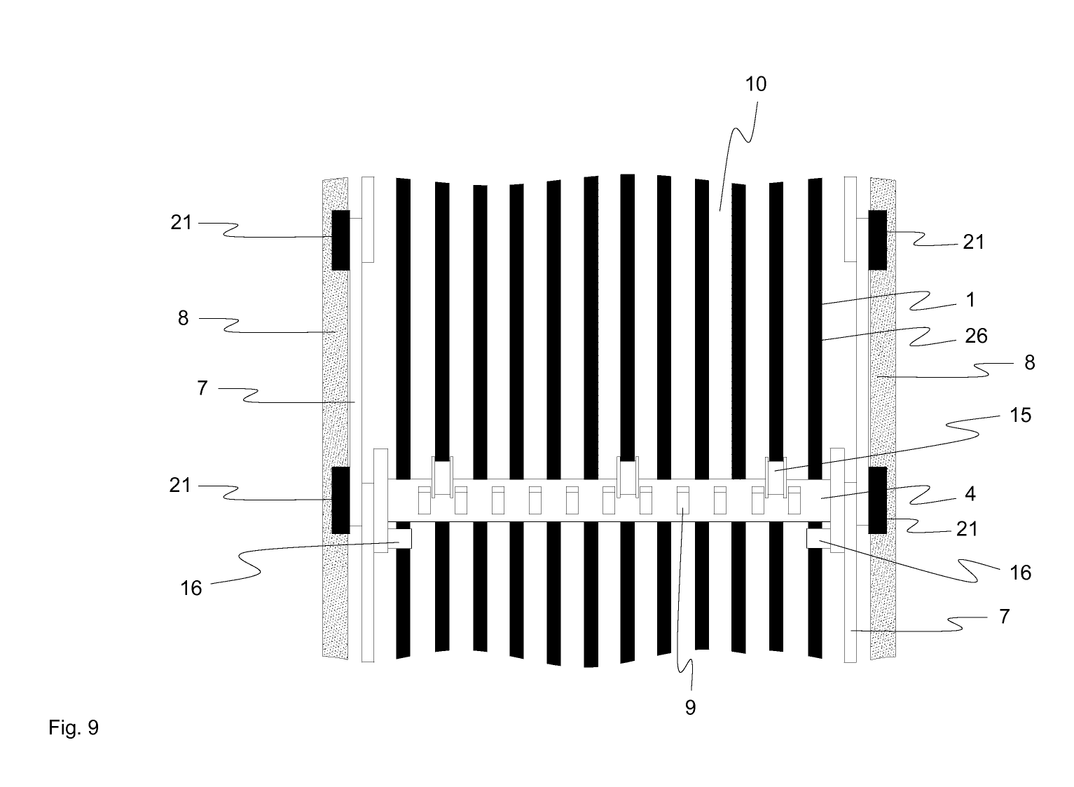

FIG. 9 a section of a sieve device according to the invention showing the front side of a separation surface designed as like sieve grate,

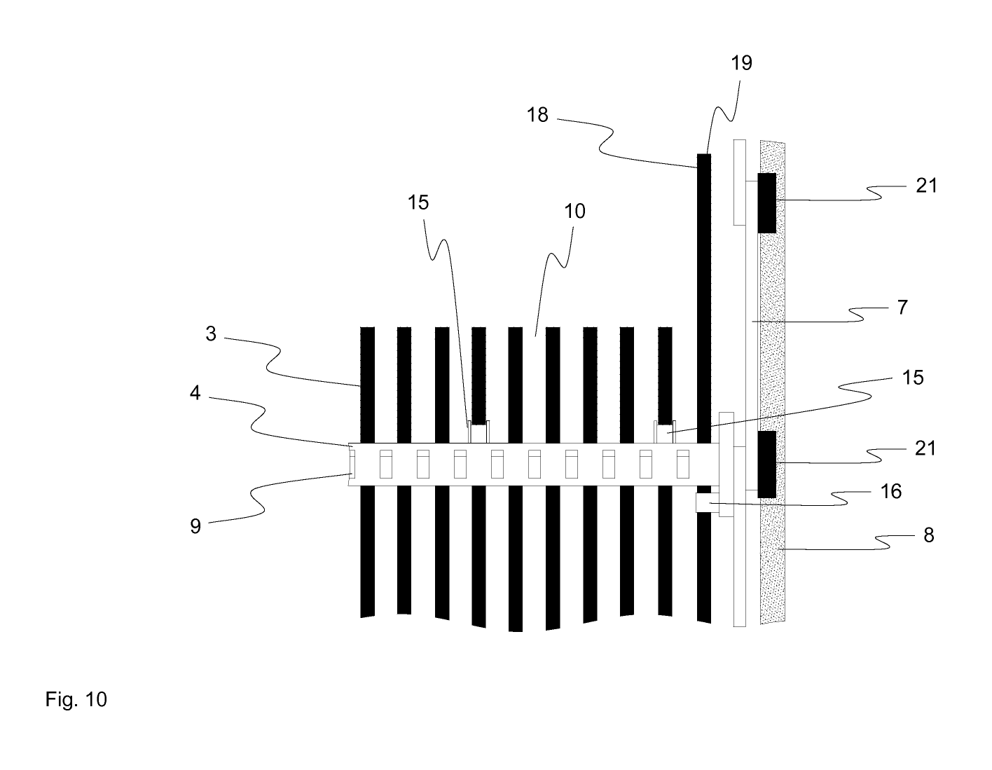

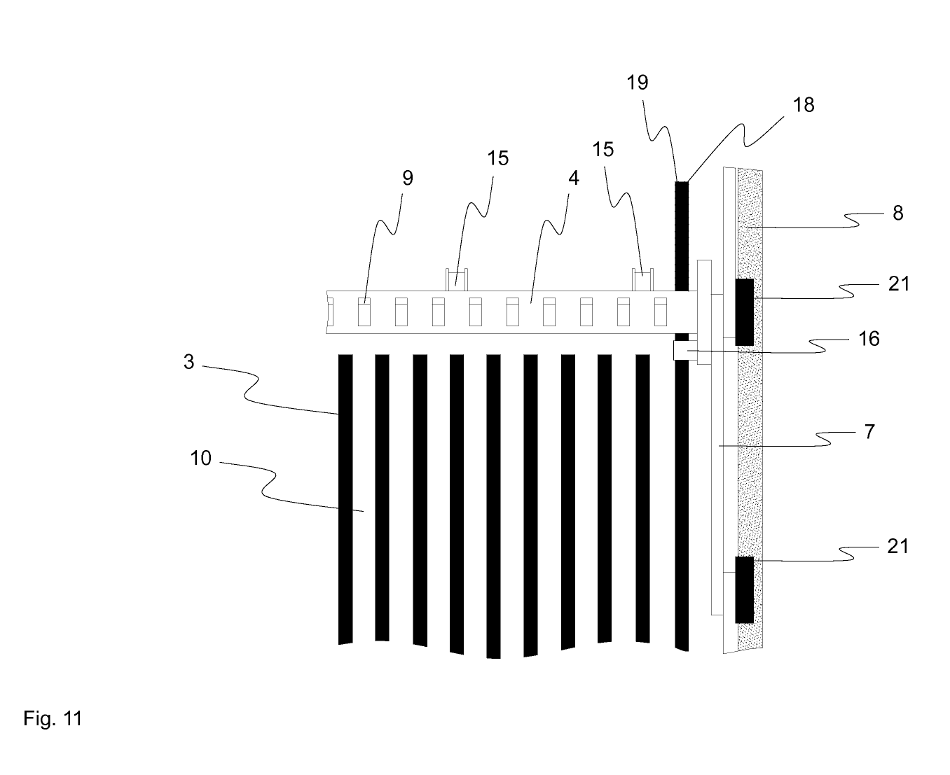

FIGS. 10 and 11 a section of a sieve device according to the invention showing the back side of the supplementary grate when the cleaning rake is in a different position,

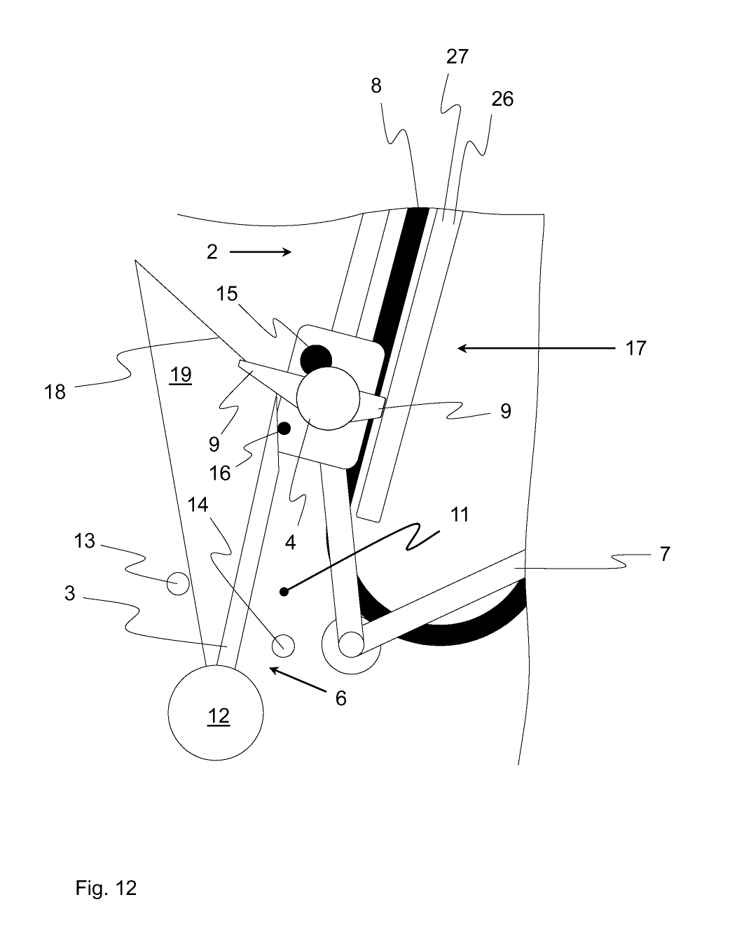

FIG. 12 a side view of a section of a sieve device according to the invention while a cleaning rake rotates, whereby the separation surface shown is designed as a closed surface element,

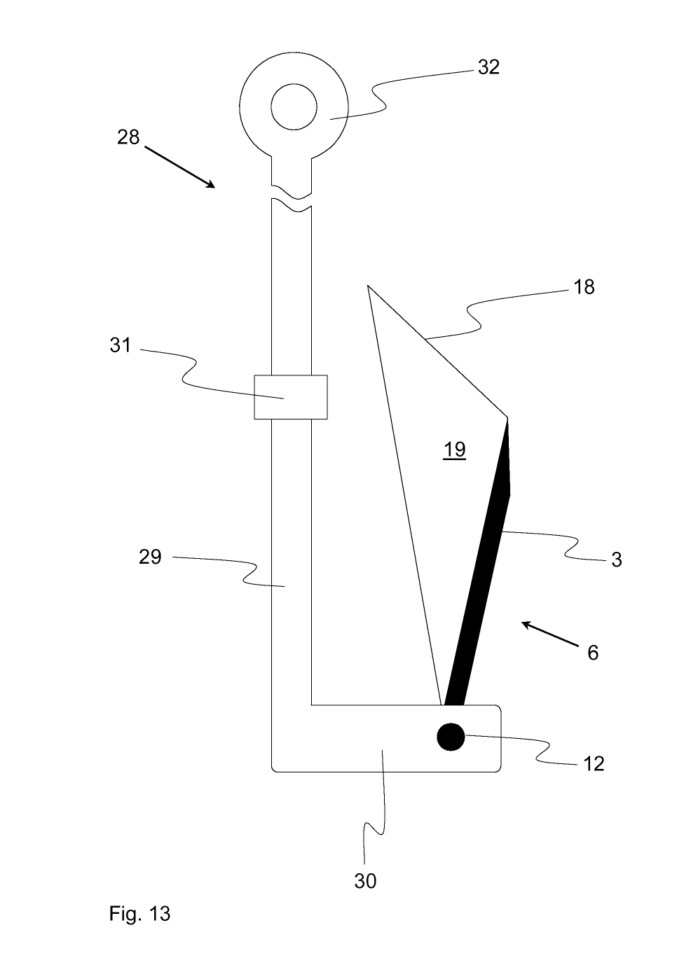

FIG. 13 another side view of a section of a sieve device according to the invention, and

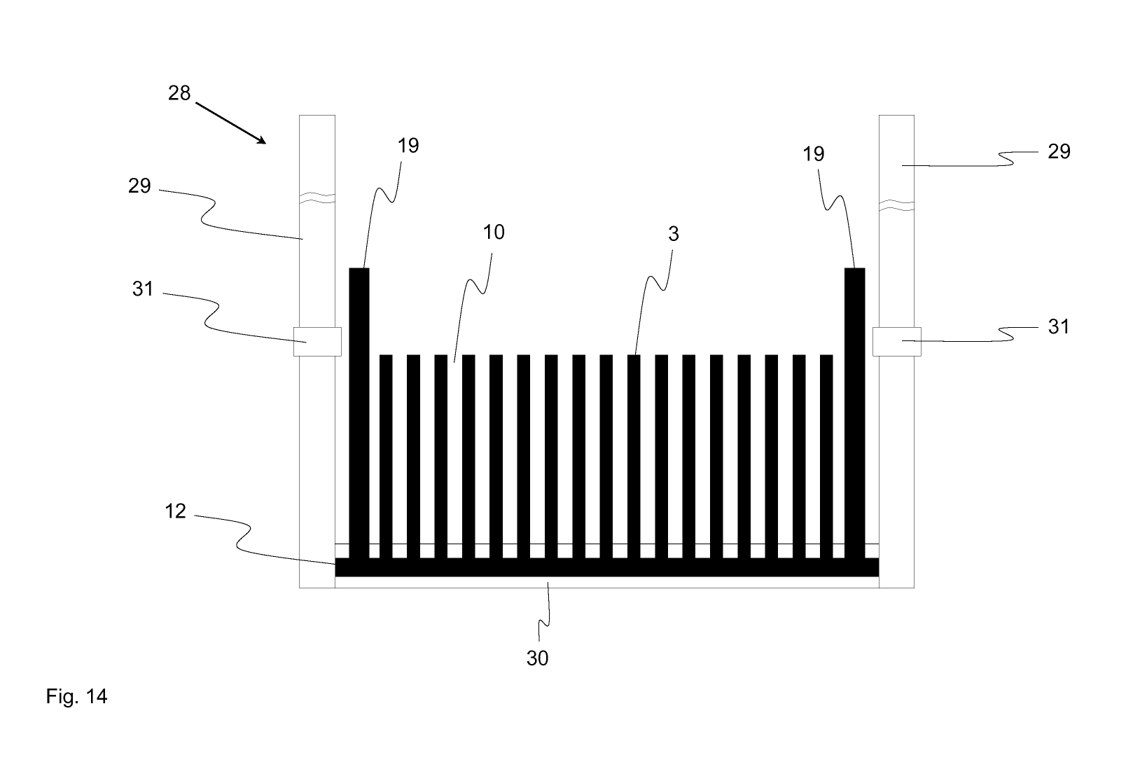

FIG. 14 a top view of the section shown in FIG. 13.

To begin with, it should be mentioned that some of the figures that show several similar structural parts indicate only one of several reference signs to ensure good clarity.

A sieve device integrated into a sewer 22 for separating and removing sieved material (such as stones, branches, etc.) is shown in FIG. 1. As can be seen in the overview of FIGS. 1 and 2, the sieve device has a centrally located separation surface 26 that enters the sewer 22 obliquely from above and is shaped as a sieve grate 1 in the embodiment shown and is connected to the sewer wall or housing 23 of the sieve device by fastening elements (not shown).

Furthermore, the sieve device has two rotating chains 7 that can be moved to rotate around the sieve grate 1 with the help of a drive 24 and are connected to one another through several cleaning rakes 4 located in between (under some circumstances, only one cleaning rake 4 can be sufficient). The rotating chains 7 are inserted into their trajectory with lateral guiding mechanisms 8, in which case these guiding mechanisms 8 can be placed in the upper and lower deflection area (as shown), but also in the areas located in between, where the rotating chains 7 run parallel to one another in the side view.

The cleaning rake 4, in turn, encompasses many cleaning prongs 9 arranged beside each other that engage in the spaces 10 of the sieve grate 1 when the cleaning rake 4 sweeps past the front side 2 of the sieve grate 1 pointing upstream when the rotating chains 7 are run in conveying direction (i.e. with regard to FIG. 1, clockwise). The sieved material held back by the sieve grate 1 (the sewer current flows from left to right in FIG. 1) is finally captured by the cleaning rake 4 or its cleaning prongs 9 and transported upwards. After the upper turning point is passed, it finally reaches, possibly via a guiding sheet metal 25, the discharge opening 5 area and from there is pushed outside to a container 20, for example. The cleaning rake 4 is finally led back to the lower turning point on the back side 17 of the sieve grate 1 so the cycle can start anew.

To prevent the sieved material from passing through the sieve grate 1 in the lower area (in which the sieve grate 1 cannot run flush with the sewer floor owing to the rotating cleaning rakes 4), it is already known to attach a supplementary grate 3 to the sewer floor that bridges the lower area.

Since it cannot rest directly on the sieve grate 1 either—after all, the cleaning rake 4 must be able to pass through the area between sieve grate 1 and supplementary grate 3—it cannot be fully ruled out in this case too that the sieved material will pass the sieve device.

To address this problem, the invention suggests moveably mounting the supplementary grate 3 to allow a relative movement between sieve grate 1 and supplementary grate 3.

The decisive advantage of the invention results from FIGS. 3 to 8, which show the lower area of a sieve device according to the invention that lies adjacently to the sewer floor, in which case the individual figures document a possible movement sequence of the cleaning rake 4 and supplementary grate 3.

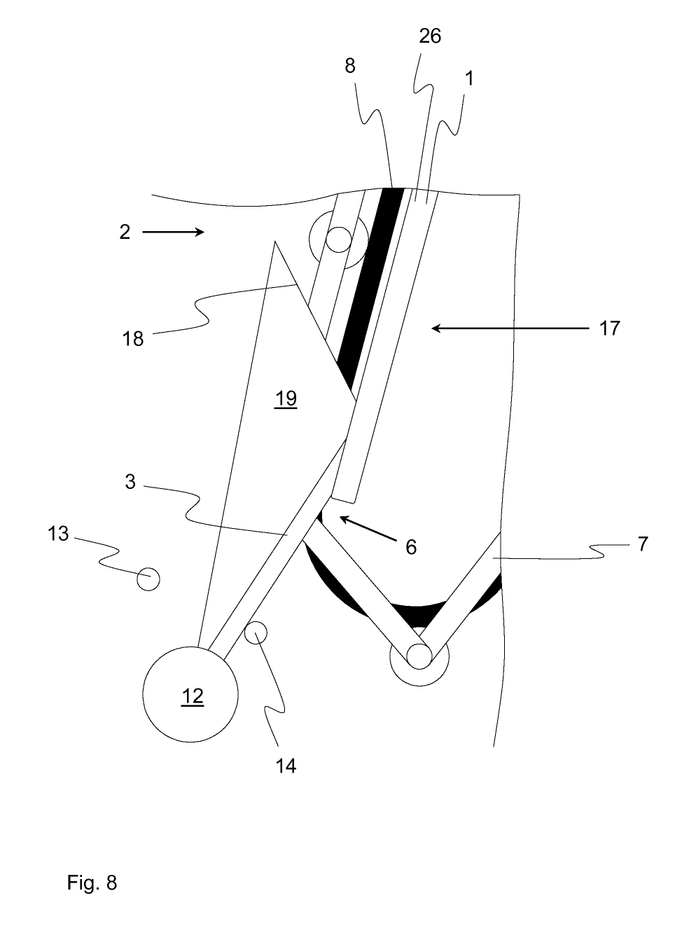

In its operating position (FIGS. 3 and 8), the supplementary grate 3—which preferably extends across the width of the sieve grate 1 that runs perpendicularly to the blade level rests either on a stop 14 (as shown) or alternatively, directly on the grate rods of the sieve grate 1. In the bottom area, it has been swivel mounted around a rotating axis 12, in which case the supplementary grate 3 should gradually merge with the sewer floor (not shown) in the area of the rotating axis 12 in a way not shown either to prevent sieved material from passing through the sieve device between sewer floor and rotating axis 12. It is conceivable to provide a sealing lip or tab between rotating axis 12 or a housing 23 enveloping the rotating axis 12 and the sewer floor to ensure a transition of the sewer floor to the sieve surface of the supplementary grate 3.

If a control mechanism initiates the sieve grate 1 cleaning process and with it, the one of the supplementary grate 3 too—the rotating chains 7 arranged on both sides of the sieve grate 1 are put clockwise into motion with the help of a drive 24 (cf. FIG. 1), preferably mounted on the upper section of the sieve grate 1. The rotating chains 7 comprise preferably guiding rollers 21, which are led along the desired orbit of the cleaning rake 4 with the help of the corresponding guiding mechanism 8.

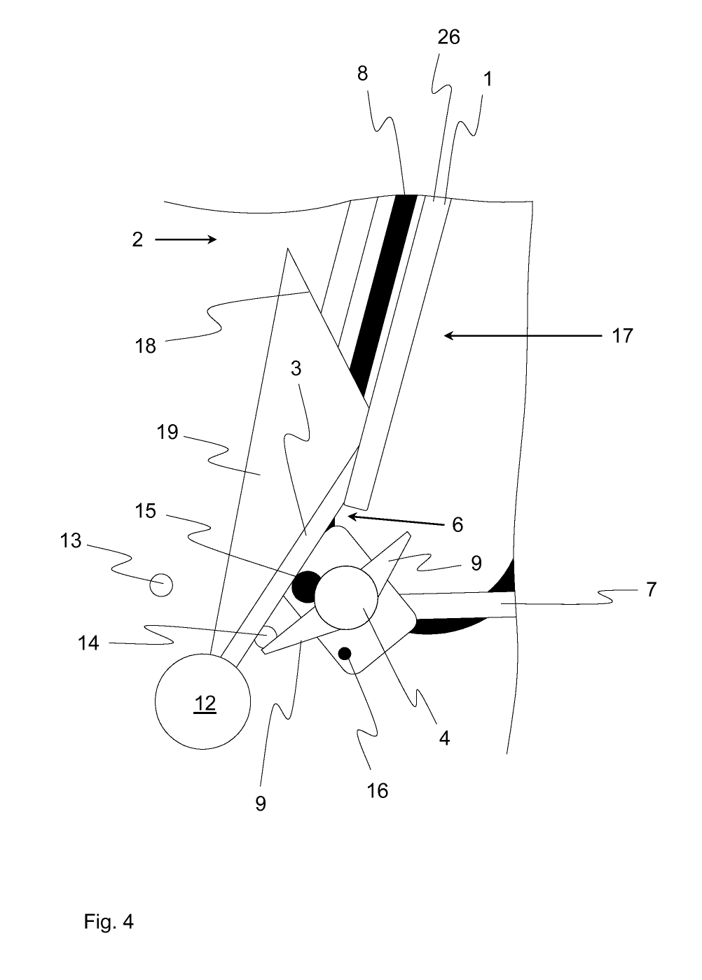

After a first contact area 15 of the cleaning rake 4 (e.g. in form of one or several rollers arranged separately across the width of the cleaning rake 4 (cf. FIGS. 9-11)) has made contact with one or several cleaning prongs 9 (FIG. 4), the continued clockwise movement of the cleaning rake 4—and with it, in conveying direction—causes a swiveling of the supplementary grate 3 around its rotating axis 12 into a passing position. In this process, the swiveling is caused exclusively by the proximal movement of the cleaning rake 4 that presses the supplementary grate 3 sideways with the help of the first contact area 15 (i.e. with regard to FIG. 4, to the left). As a result of this, a free space 11 is finally created between sieve grate 1 and supplementary grate 3 that allows the cleaning rake 4 to pass (=passing position).

While the movement of the cleaning rake 4 in conveying direction mentioned above takes place, the cleaning prongs 9 arranged on both sides grab both the sieve grate 1 from the front and the swiveled supplementary grate 3 through from behind. This removes adhered sieved material from the sieve areas and transports it upwards to the discharge opening 5 (see FIG. 1).

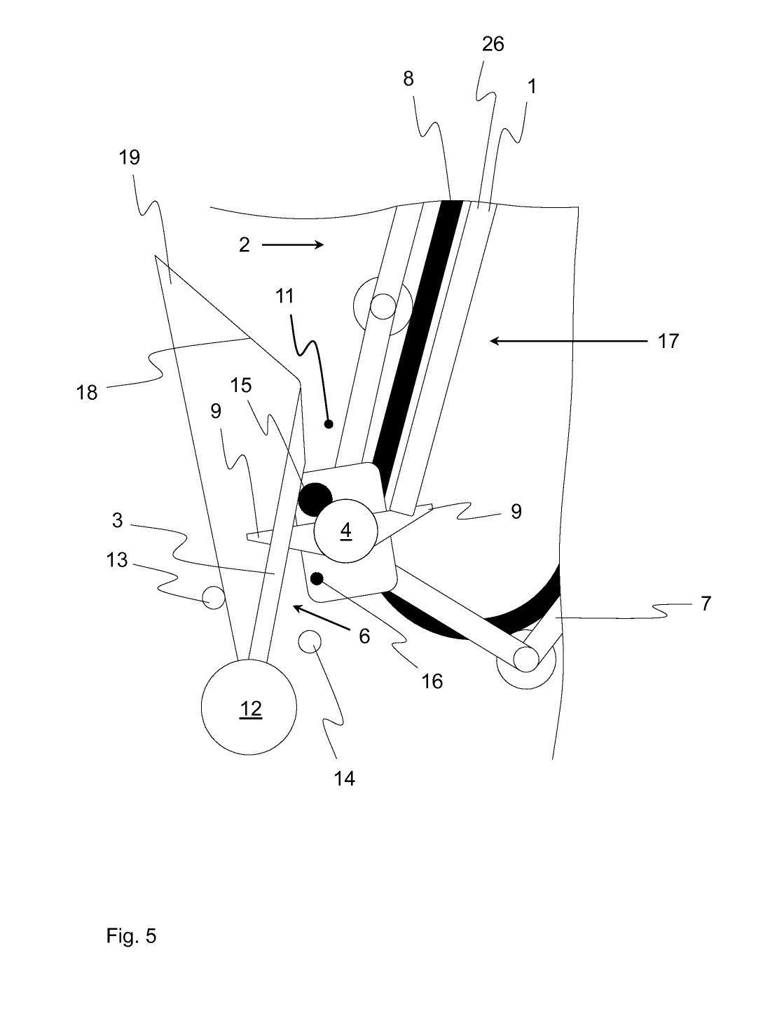

Starting in a certain position of the cleaning rake 4 (cf. FIGS. 5 & 6), a second contact area 16 of the cleaning rake 4 (which can be formed, for example, by a roller mounted on each side, see FIG. 9) finally makes contact with the supplementary grate 3. Thus, the supplementary grate 3 is handed over from the first contact area 15 to the second contact area 16.

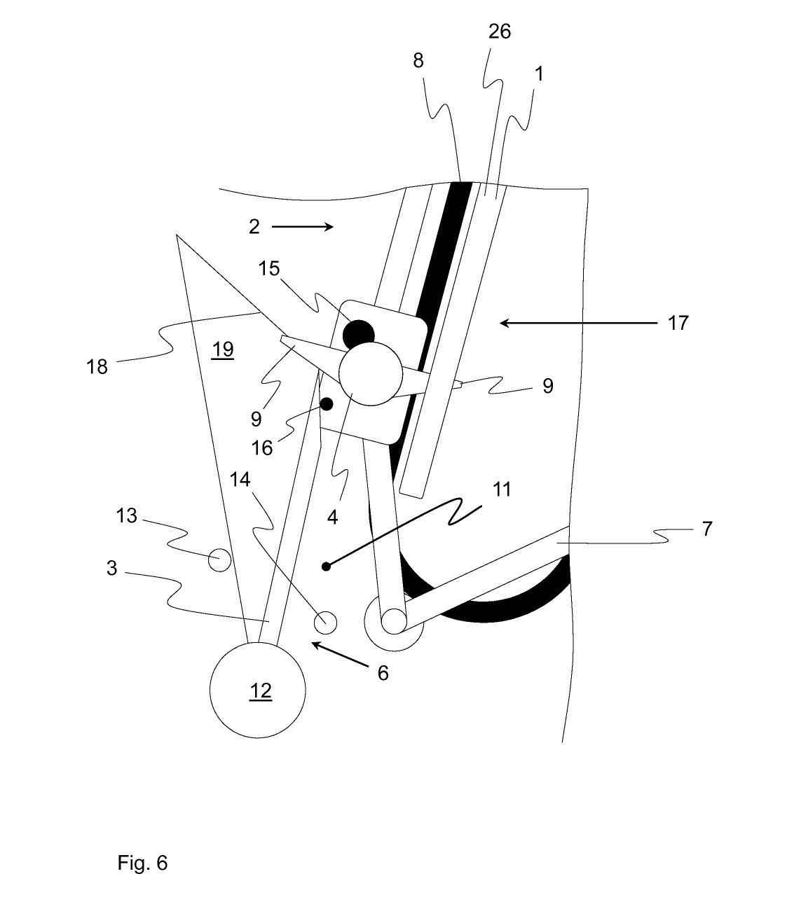

To prevent excessive swiveling of the supplementary grate 3, it can be advantageous if a limiter 13 designed like a stop pad is assigned to it. The supplementary grate 3 finally rests on it before it is swiveled again toward its operating position after passing the cleaning rake 4 (see FIGS. 6-8, which show consecutive states of the supplementary grate 3 while the cleaning rake 4 passes by). In this case, the swiveling can be spring supported or merely takes place due to gravity. In the latter case, the rotating axis 12 of the supplementary grate 3 or the limiter 13 is placed in such a way that the center of gravity of the supplementary grate 3 lies in any position between sieve grate 1 and rotating axis 12. In the final analysis, this ensures that the supplementary grate 3 will always automatically “fall back” to its operating position when there is no cleaning rake 4 in this area.

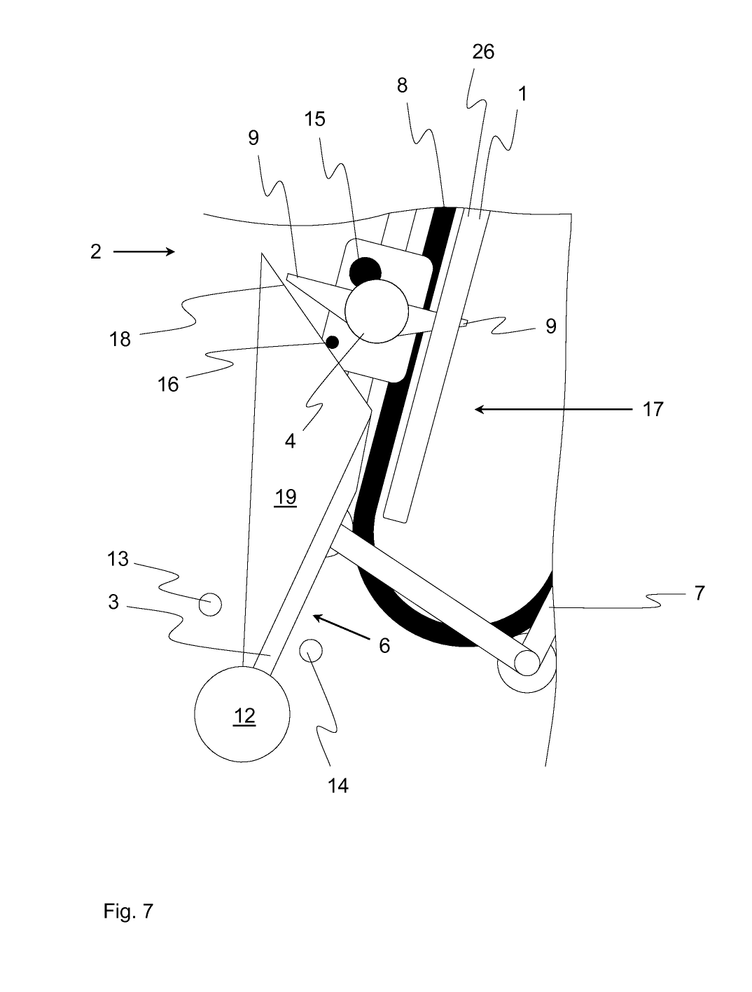

As can be especially seen in FIG. 7 in connection with FIGS. 10 and 11 (a view of the back side 6 of the supplementary grate 3 from the free space 11 between sieve grate 1 and supplementary grate 3 is shown), the rollers that create the second contact area 16 do not rest on the grate rods of the supplementary grate 3. Rather, the latter preferably has, for example, a trapezoidal or triangular guiding element 19 on both sides, which protrudes downstream from the sieve area of the supplementary grate 3 (FIGS. 10 & 11 show only one side, the second side is similarly shaped in accordance with FIG. 9).

On the one hand, the guiding element 19 ensures that the supplementary grate 3 will not strike the grate rods of the sieve grate 1 uncontrollably when it swivels from the passing position to the operating position, and gradually cause the corresponding damage or excessive noise. In this context, a comparison of FIGS. 10 & 11 shows that, starting with a certain position of the cleaning rake 4, the additional rake rests merely only above the guiding element(s) 19 on the cleaning rake 4 or the second contact area 16.

On the other hand, the arrangement of the guiding element 19 (which can be arranged only on one side or both of the supplementary grate 3) has the decisive advantage that the cleaning rake 4 can also be passed by the supplementary grate 3 against the conveying direction without causing a collision between cleaning rake 4 and supplementary grate 3 while doing this. Such an operation can become necessary, for example, when sieved material is wedged in the sieve grate 1 or supplementary grate 3 in such a way that the cleaning rake 4 can no longer be moved in conveying direction.

A corresponding movement sequence of cleaning rake 4 and supplementary grate 3 takes place when FIGS. 3-8 are looked at in reversed order. In this case, the cleaning rake 4 moves counterclockwise and makes contact with the additional rake only above the second contact area 16 first. Since the guiding element 19 is preferably equipped with a run-up slope 18, the additional rake is finally swiveled from its operational position towards its passing position when the cleaning rake 4 keeps moving against the conveying direction. The cleaning rake 4 finally moves downwards between the swiveled additional rake and the sieve rake, i.e. through the free space 11 created during swiveling. After passing, the additional rake swivels back to its operating position by itself, so that the free space 11 created for a short time closes again and the gap between additional rake and sieve rake through which the sieved material could pass no longer exists.

FIG. 12 shows another embodiment of the invention. Instead of the sieve grate 1 described above, a closed surface element 27 that also serves as separation surface 26 is used. Here, the cleaning prong(s) 9 assigned to the separation surface 26 should be correspondingly modified (the indicated cleaning prong 9 pointing towards the separation surface 26 could, for example, be designed as a scraper perpendicular to the blade level with whose help the sieved material held back by the supplementary grate 3 or the closed material or the closed surface element 27 can be transported upwards along the separation surface 26). The closed surface element 27 can, for example, exist as a separation plate designed perpendicularly to the blade level. Finally, it could also be conceivable to design the separation surface 26 as separation plate having many perforations in the form of bore holes, for example, so that a certain sieve effect (similar to that of the sieve grate 1) could also be accomplished here.

Finally, another advantageous further development of the invention can be seen in the overview of FIGS. 13 & 14. Thus, it can be desirable to raise the supplementary grate 3 a little hit in case there is a defect or the cleaning rake 4 accidentally stops. As a result of this, a gap is finally created between the original resting surface of the supplementary grate 3 (e.g. a sewer floor or an intermediate landing mounted in the sewer floor), so that the actual liquid to be cleaned (e.g. sewage) can pass unpurified through the device according to the invention underneath the supplementary grate 3. In this case, a clogging of the supplementary grate 3 and/or of the separation surface 26 can be prevented. After the cleaning rake 4 resumes operation, the supplementary rake 3 can finally be lowered to its original position to close the gap mentioned above.

From the structural point of view, this means that it can be advantageous for the supplementary rake 3 to be linked to a lifting unit 28 so it can be lifted with it using a rope winch or another hoisting device, for example. The lifting unit 28 comprises, for example, rods 29 that can, in turn, encompass a supporting section 30 arranged in the lower part of the supplementary grate 3.

It is furthermore advantageous for the rods 29 or supplementary grate 3 to be inserted through one or several fixed guiding elements 31 (schematically shown in FIGS. 13 & 14). The guiding elements 31 can be mounted on a sewer wall or basic frame of the device according to the invention, for example, for guiding the supplementary grate 3 preferably in vertical or horizontally inclined direction.

Finally, the lifting unit 28 or its rods 29 can have a seat shaped like an eyelet 32, for example, through which it can be linked to the hoisting device mentioned above.

Incidentally, the invention is not restricted to the embodiments shown. Rather, all combinations of the individual characteristics, as shown or described in the claims, description and figures, are the object of the invention as far as a corresponding combination is technically feasible or makes sense.

For example, it is possible to do without the rollers shown in the figures, so that the first contact area is created by a surface of the cleaning rake. Furthermore, the second contact area or the guiding element is not indispensable (for example, when a movement of the cleaning rake against the conveying direction is not de-sired).

It could also be conceivable to equip the housing or guiding element of the sieve device with additional lateral guiding elements in the area of the rotating chains on which the cleaning rake rests sideways while it moves (i.e. with regard to FIG. 9, to the left and/or right of the cleaning rake). The guiding rail finally ensures that the cleaning rake does not drift away from its predetermined trajectory in transverse direction (i.e. in FIG. 9 to the left or right). In this case, it is advantageous for the mutual separation of the guiding rails to be adjustable relative to one another so the position of the cleaning rake in transversal direction can be adjusted in such a way that its prongs engage exactly in the spaces of the sieve grate or supplementary grate. This allows manufacturing tolerances to be compensated. Here, the displacement of the guiding rails can be made possible by providing them with oblong holes so screw connections arranged in a stationary way can grab them. After the corresponding adjustment, the screw connections are finally tightened so the cleaning rake can be laterally inserted.

### LIST OF REFERENCE CHARACTERS

1 Sieve grate
2 Front side of the sieve grate
3 Supplementary grate
4 Cleaning rake
5 Discharge opening
6 Back side of the supplementary grate
7 Rotating chain
8 Guiding mechanism
9 Cleaning prongs
10 Space
11 Free space
12 Rotating axis
13 Limiter
14 Stop
15 First contact area
16 Second contact area
17 Back side of the separation area
18 Run-up slope
19 Guiding element
20 Container
21 Guiding rollers
22 Sewer
23 Housing
24 Drive
25 Guiding plate
26 Separation area
27 Closed surface element
28 Lifting unit
29 Rods
30 Supporting section
31 Guiding element
32 Eyelet

1. Device for separating and removing sieved material from a flowing liquid such as sewage,
in which case the device has a separation surface (26) with a front side (2) pointing upstream while the device is operating,
in which case, in a lower section of the separation surface (26), the device has a sieve surface with a supplementary grate (3) positioned upstream before the separation surface (26),
in which case the device comprises a drive (24) and a cleaning rake (4) that can be driven to revolve in conveying direction with the help of the drive (24),
in which case the cleaning rake (4) can be moved while operating along at least one partial section of the front side (2) of the separation surface (26) in order to remove sieved material held back by the separation surface (26) and transport it towards a discharge opening (5), and
in which case the cleaning rake (4), while moving along a downstream-pointing back side (6) of the supplementary grate (3), can be moved in order to remove sieved material held back by the supplementary grate (3) and transport it towards a discharge opening (5),
characterized in that
the supplementary grate (3) can be moved relative to the separation surface (26).

2-20. (canceled)
